(19) United States
(12) Patent Application Publication
(10) Pub. No.: US 2014/0143346 A1
(43) Pub. Date: May 22, 2014

(54) Identifying And Classifying Travelers Via Social Media Messages

(71) Applicant: INTERNATIONAL BUSINESS MACHINES CORP, Armonk, NY (US)

(72) Inventors: Jalal U. Mahmud, San Jose, CA (US); Jeffrey W. Nichols, San Diego, CA (US)

(73) Assignee: INTERNATIONAL BUSINESS MACHINES CORPORATION, Armonk, NY (US)

(21) Appl. No.: 13/679,241

(22) Filed: Nov. 16, 2012

(51) Int. Cl. G06F 15/16

(52) U.S. Cl. 709/206

(57) ABSTRACT

The method includes collecting a first plurality of social media messages, where each of the first plurality of social media messages contains a respective location of a first social media user; determining a first plurality of geographical distances between the respective locations contained in the first plurality of social media messages; determining a maximum or average geographical distance from the first plurality of geographical distances; and comparing the maximum or average geographical distance to a first or second threshold to determine if the first social media user is a traveler. For a plurality of social media messages, where each of the social media messages does not contain a respective location of a social media user, the method includes extracting content from the plurality of social media messages and comparing the extracted content to a traveler model to determine if the social media user is a traveler.

### FIELD OF THE INVENTION

The present invention relates generally to social media, and more particularly to identifying and classifying social media users as travelers via social media messages.

### BACKGROUND

Social media is growing at a rapid pace as people continue to use it more and more in their daily lives. People from all walks of life share their thoughts, ideas and recent or upcoming activities and excursions with the world through social media. As social media has become a more integral part of our lives, companies have begun to view social media as another resource that can be used to connect with a target audience. This has led to the development of various social media applications that result in a company gaining insight into their customers' habits, practices, and interests like never before. One such application is the use of social media to determine the location of a social media user. Typically, social media location detection algorithms analyze a set of social media messages/updates collected over a period of time and determine the location of the user based on the content of the social media messages. However, these algorithms do not take into account users who have traveled during that period of time. This can lead to inaccuracies in determining the home location of a user, especially with regard to a social media user who is a frequent traveler.

### SUMMARY

Embodiments of the present invention provide a system, method, and program product for identifying and classifying travelers via social media messages. Collecting a first plurality of social media messages, where each of the first plurality of social media messages contains a respective location of a first social media user. Determining a first plurality of geographical distances between the respective locations contained in the first plurality of social media messages. Determining a maximum or average geographical distance from the first plurality of geographical distances. Determining that the maximum geographical distance surpasses a first threshold value or the average geographical distance surpasses a second threshold value and classifying the first social media user as a traveler.

In another embodiment, collecting a first plurality of social media messages, wherein each of the first plurality of social media messages either contains a respective location of a first social media user or no respective location of the first social media user. If a percentage of said messages of the first plurality of social media messages that contain a location surpasses a first threshold value, determining a first plurality of geographical distances between the respective locations contained in the first plurality of social media messages, determining a maximum geographical distance or an average geographical distance from the first plurality of geographical distances, determining that the maximum geographical distance surpasses a second threshold value or the average geographical distance surpasses a third threshold value, and classifying the first social media user as a traveler.

If a percentage of said messages of the first plurality of social media messages that contain a location does not surpass a first threshold value, extracting content from the first plurality of social media messages, determining that an amount of extracted content from the first plurality of social media messages that matches the content contained in a traveler model surpasses a fourth threshold value, and classifying the first social media user as a traveler.

### BRIEF DESCRIPTION OF THE SEVERAL VIEWS OF THE DRAWINGS

FIG. 1 illustrates a traveler identification system, in accordance with an embodiment of the invention.

FIGS. 2 and 3 is a flowchart illustrating the operations of the traveler identification program of FIG. 1 in determining if a social media user is a traveler and a frequent traveler, in accordance with an embodiment of the invention.

FIGS. 4 to 5 is a flowchart illustrating the operations of the traveler identification program of FIG. 1 in building a traveler model, using the traveler model to classify a social media user as a traveler and a frequent traveler, in accordance with an embodiment of the invention.

FIGS. 6 and 7 is a flowchart illustrating the operation of the traveler identification program of FIG. 1 in determining the locations traveled by a social media user classified as a traveler, in accordance with an embodiment of the invention.

FIG. 8 is a block diagram depicting the hardware components of the traveler identification system of FIG. 1, in accordance with an embodiment of the invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

Embodiments of the present invention will now be described in detail with reference to the accompanying Figures.

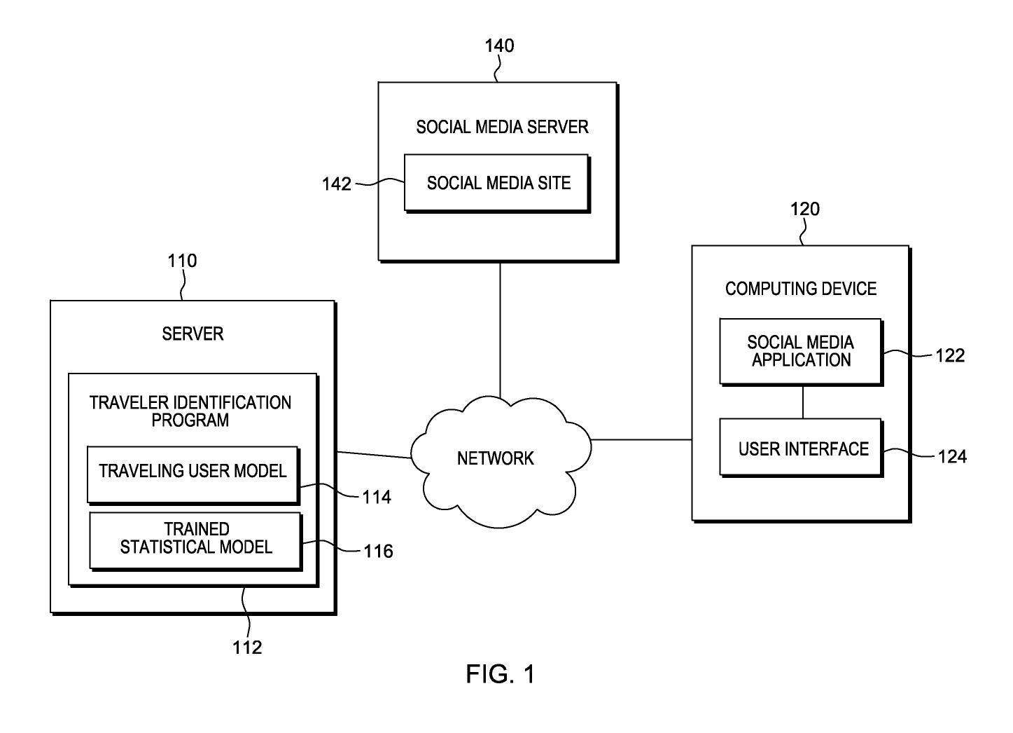

FIG. 1 illustrates traveler identification system 100, in accordance with an embodiment of the invention. Traveler identification system 100 includes server 110, computing device 120 and social media server 140, interconnected over network 130.

In an exemplary embodiment, network 130 is the Internet, representing a worldwide collection of networks and gateways to support communications between devices connected to the Internet. In the exemplary embodiment, network 130 is also a collection of networks and gateways capable of communicating global positioning information between devices connected to the network. Network 130 may include, for example, wired, wireless or fiber optic connections. In other embodiments, network 130 may be implemented as an intranet, a local area network (LAN), or a wide area network (WAN). In general, network 130 can be any combination of connections and protocols that will support communications between server 110, computing device 120 and social media server 140, in accordance with embodiments of the invention.

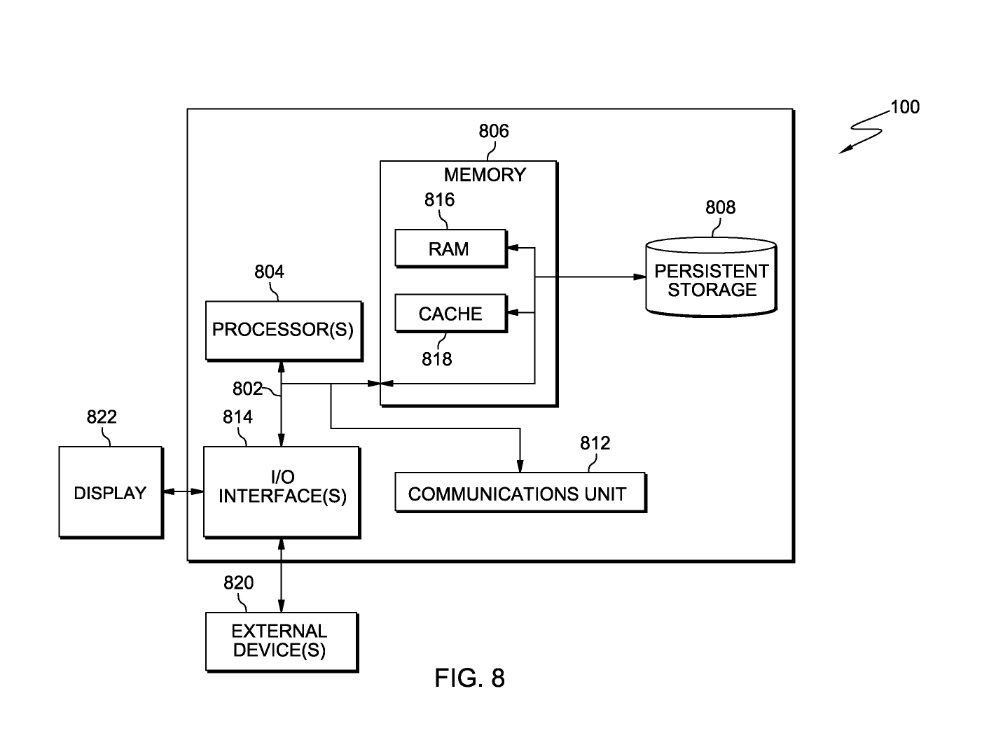

Social media server 140 includes social media site 142. Social media server 140 may be a desktop computer, a notebook, a laptop computer, a tablet computer, a handheld device, a smart-phone, a thin client, or any other electronic device or computing system capable of receiving and sending data to and from other computing devices such as computing device 120 and server 110 via network 130. Although not shown, optionally, social media server 140 can comprise a cluster of web servers executing the same software to collectively process the requests for the web pages as distributed by a front end server and a load balancer. In an exemplary embodiment, social media server 140 is a computing device that is optimized for the support of websites which reside on social media server 140, such as social media site 142, and for the support of network requests related to web sites, which reside on social media server 140. Social media server 140 is described in more detail with reference to FIG. 8.

Social media site 142 is a collection of files including, for example, HTML files, CSS files, image files and JavaScript files. Social media site 142 can also include other resources such as audio files and video files. In an exemplary embodiment, social media site 142 is a social media website such as Facebook™, Twitter™, Linkedin™, or Myspace™.

Computing device 120 includes social media application 122 and user interface 124. Computing device 120 may be a desktop computer, a notebook, a laptop computer, a tablet computer, a handheld device, a smart-phone, a thin client, or any other electronic device or computing system capable of receiving and sending data to and from server 110 and social media server 140 via network 130. Computing device 120 is described in more detail with reference to FIG. 8.

User interface 124 includes components used to receive input from a user and transmit the input to an application residing on computing device 120. In an exemplary embodiment, user interface 124 uses a combination of technologies and devices, such as device drivers, to provide a platform to enable users of computing device 120 to interact with social media application 122. In the exemplary embodiment, user interface 124 receives input, such as textual input received from a physical input device, such as a keyboard, via a device driver that corresponds to the physical input device.

Social media application 122 is a software application capable of receiving inputted information from a user of computing device 120 via user interface 124 and transmitting the inputted information to another computing device, such as server 110 or social media server 140, via network 130.

Server 110 includes traveler identification program 112. Server 110 may be a desktop computer, a notebook, a laptop computer, a tablet computer, a handheld device, a smart-phone, a thin client, or any other electronic device or computing system capable of receiving and sending data to and from computing device 120 and social media server 140 via network 130. Server 110 is described in more detail with reference to FIG. 8.

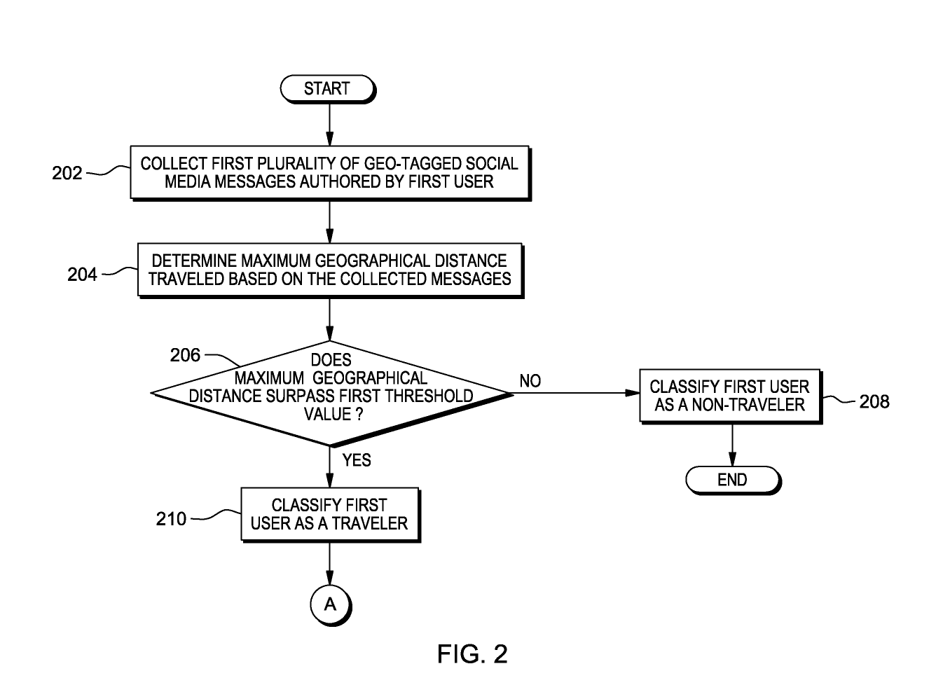

Traveler identification program 112 includes traveling user model 114 and trained statistical model 116. In the exemplary embodiment, traveler identification program 112 includes components to analyze social media messages received from social media server 140 via network 130 and determine travel classifications of a social media user. The operation of traveler identification program 112 is described in further detail below with reference to FIGS. 2 through 7.

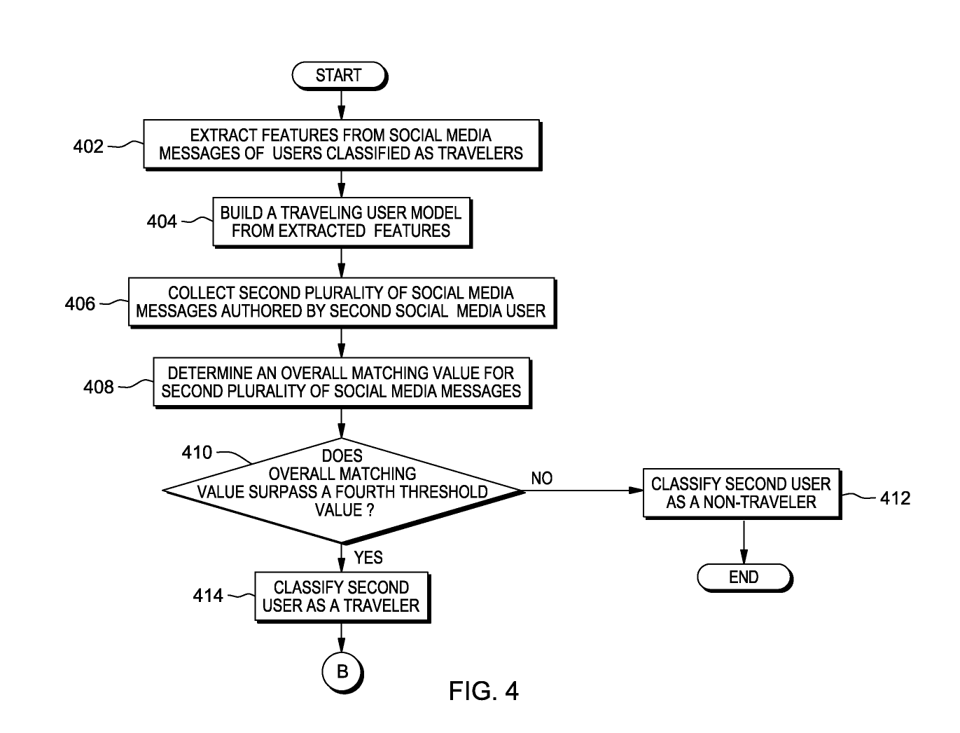

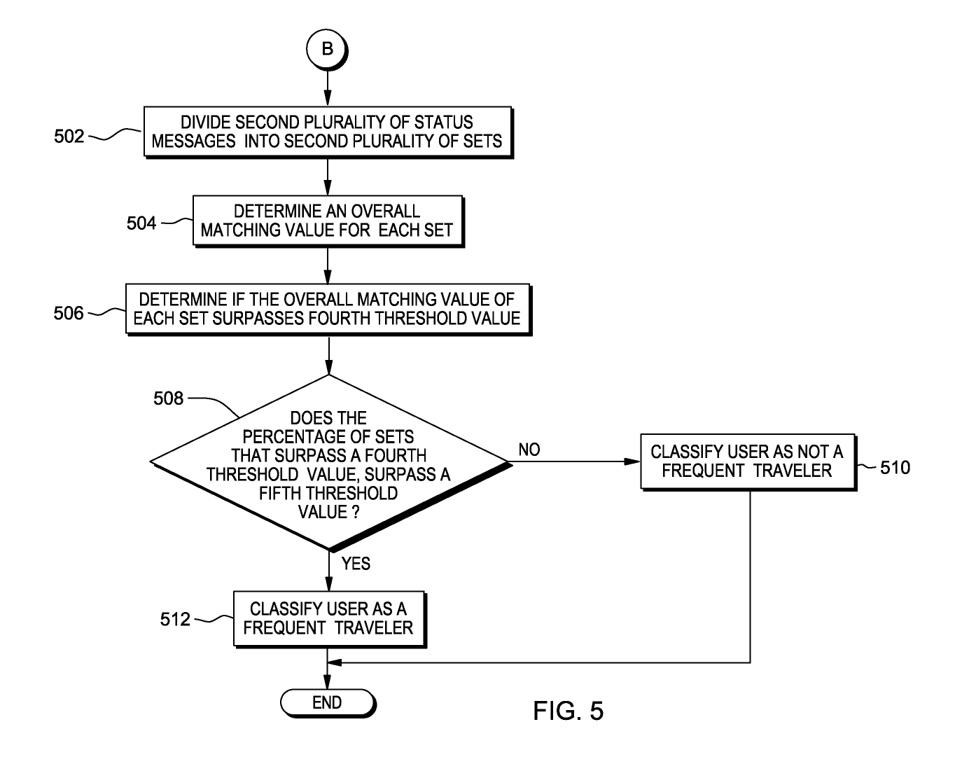

In the exemplary embodiment, traveling user model 114 is a model dataset used by traveler identification program 112 for comparison analysis in determining a travel classification of a social media user. Traveling user model 114 is described in further detail with reference to FIGS. 4 and 5.

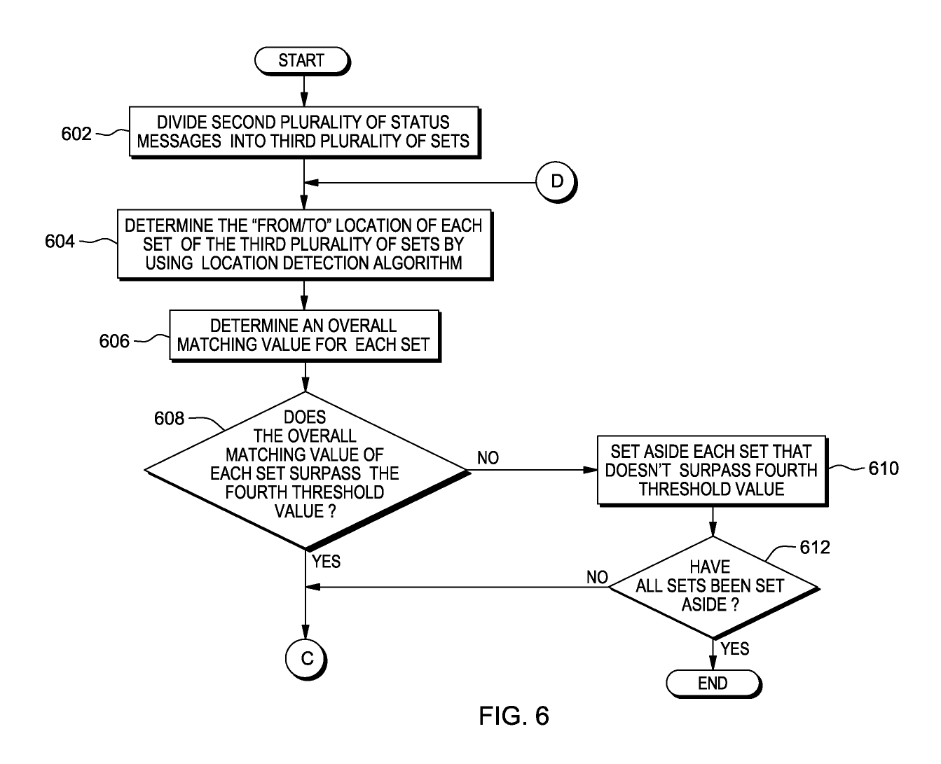

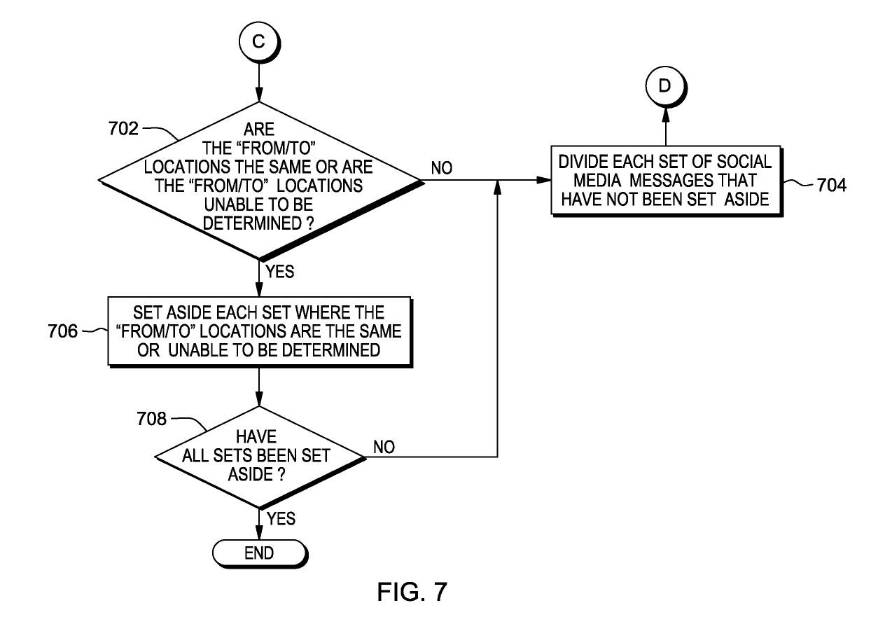

In the exemplary embodiment, trained statistical model 116 is a program capable of analyzing portions of social media messages and determining a location classification based on a comparison analysis. Trained statistical model 116 is described in further detail with reference to FIGS. 6 and 7.

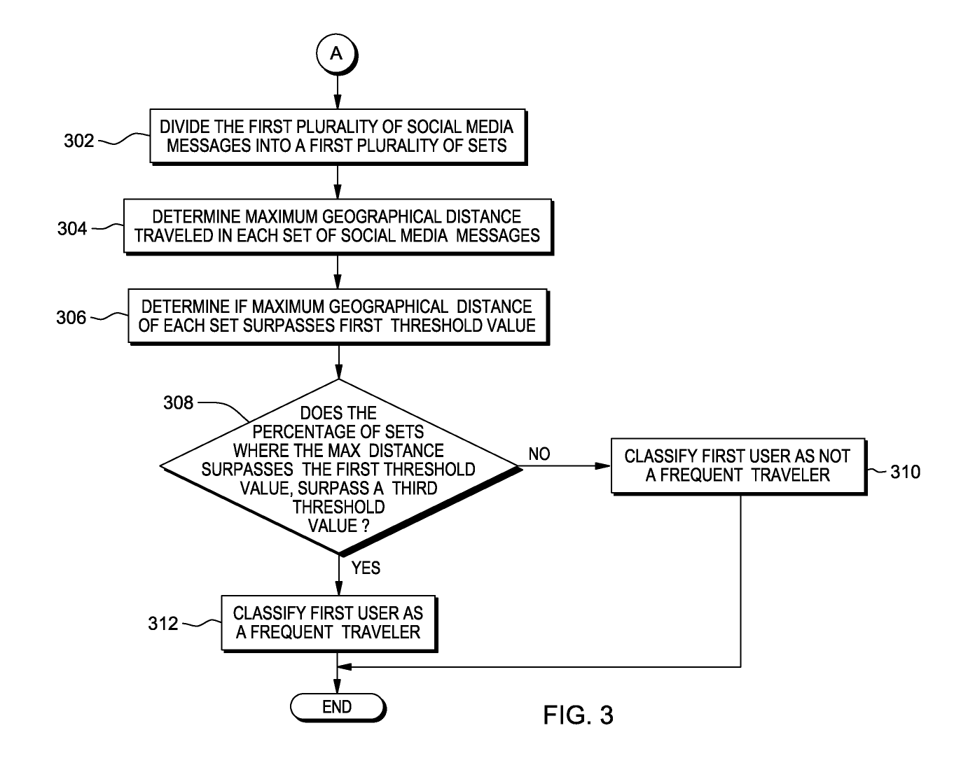

FIGS. 2 and 3 is a flowchart illustrating the operations of traveler identification program 112 in determining if a social media user is a traveler and a frequent traveler, in accordance with an exemplary embodiment of the invention. In an exemplary embodiment, traveler identification program 112 collects a first plurality of geo-tagged social media social media messages/updates authored by a first user from social media site 142 via network 130 (step 202). In the exemplary embodiment, geo-tagged social media social media messages are social media messages that have location information such as latitude/longitude, landmarks, exact addresses, commercial business names (such as restaurants), and city names. The location information is typically found in the metadata of the social media message. For example, social media users that subscribe to Foursquare.com™, in essence, consent to location information being placed in the metadata of the social media messages that the user posts. For some social media services, such as Foursquare.com™, traveler identification program 112 sends a request to the application programming interface (API) of the social media service in order to retrieve the metadata of a social media message. For other social media services, such as Twitter™, for example, the metadata accompanies the social media message so there is no need for traveler identification program 112 to make a separate call to the API of the social media service to retrieve the metadata of a social media message. In another embodiment, the first plurality of social media messages may also contain social media messages which do not contain location information.

In the exemplary embodiment, traveler identification program 112 then determines the maximum geographical distance the first user has traveled based on the collected geo-tagged social media messages (step 204). In the exemplary embodiment, traveler identification program 112 determines the geographical distance between the locations described in the collected geo-tagged social media messages. For example, if traveler identification program 112 collects three geo-tagged social media messages, a geographical distance is determined between the locations described in the first and second social media messages, between the locations described in the first and third social media messages and between the locations described in the second and third social media messages. Traveler identification program 112 then determines a maximum geographical distance from the three determined geographical distances. In other embodiments, traveler identification program 112 determines the average geographical distance the first user has traveled based on the collected geo-tagged social media messages. With regard to the example above, instead of determining the maximum geographical distance from the three determined geographical distances, traveler identification program 112 averages the three determined geographical distance to determine an average geographical distance. In other embodiments, traveler identification program 112 determines if the number of social media messages of the first plurality of social media messages, which contain location information, surpasses a location information threshold value, in order to determine if the first plurality of social media messages contains enough location information, before calculating a maximum or average geographical distance. The location information threshold value represents a threshold percentage of social media messages which contain location information. In this embodiment, the location information threshold value is 50%, however, in other embodiments the location information threshold value may be another value. In this embodiment, if traveler identification program 112 determines the number of social media messages of the first plurality of social media messages surpasses the location information threshold value, traveler identification program 112 proceeds to step 204 and determines the maximum or average geographical distance of the first plurality of social media messages. If traveler identification program 112 determines the number of social media messages of the first plurality of social media messages does not surpass the location information threshold value, traveler identification program 112 determines if the first social media user is a traveler by way of a comparison to a traveler model. The specifics involved in this determination are discussed below with regard to FIGS. 4 and 5.

Traveler identification program 112 then determines if the maximum geographical distance surpasses a first threshold value (decision 206). In the exemplary embodiment, the first threshold value is a geographical distance of 50 miles. In other embodiments, the first threshold value can be any another geographical distance chosen by the user or administer of server 110. If traveler identification program 112 determines the maximum geographical distance surpasses the first threshold value (decision 206, “YES” branch), traveler identification program 112 classifies the first user as a “traveler” (step 210). If traveler identification program 112 determines the maximum geographical distance does not surpass the first threshold value (decision 206, “NO” branch), traveler identification program 112 classifies the first user as a “non-traveler” (step 208).

In other embodiments, traveler identification program 112 determines if the average geographical distance surpasses a second threshold value. If traveler identification program 112 determines the average geographical distance surpasses the second threshold value, traveler identification program 112 classifies the first user as a “traveler”. If traveler identification program 112 determines the average geographical distance does not surpass the second threshold value, traveler identification program 112 classifies the first user as a “non-traveler”. In this embodiment, the exemplary second threshold value is a geographical distance of 20 miles. In other embodiments, the second threshold value can be any other geographical distance chosen by the user or administer of server 110. A second threshold value is used because it is assumed that a maximum geographical distance would be greater than an average geographical distance determined for the same group of social media messages. Therefore, the second threshold value that the average geographical distance must surpass for a user to be classified as a traveler should be different, or more specifically, less than the first threshold value the maximum geographical distance must surpass for a user to be classified as a traveler.

If the first user is classified as a “traveler” (step 210), traveler identification program 112 divides the first plurality of geo-tagged social media messages into a first plurality of sets, where each set contains at least two social media messages (step 302). In the exemplary embodiment, traveler identification program 112 then determines the maximum geographical distance traveled by the first user in each set of the first plurality of sets of geo-tagged social media messages (step 304). In the exemplary embodiment, to accomplish this step, traveler identification program 112 determines the geographical distance between the locations described in the geo-tagged social media messages of each set. For example, if set 1 contains three geo-tagged social media messages, a geographical distance is determined between the locations described in the first and second social media messages, between the locations described in the first and third social media messages, and between the locations described in the second and third social media messages. Traveler identification program 112 then determines which of the three geographical distances is the largest and that represents the maximum geographical distance for set 1. In another embodiment, traveler identification program 112 determines the average geographical distance traveled by the first user in each set of the first plurality of sets of geo-tagged social media messages. With regard to the example above, traveler identification program 112 averages the three determined geographical distances of set 1 to determine the average geographical distance of set 1.

Traveler identification program 112 then determines if the maximum geographical distance of each set surpasses the first threshold value (step 306). As stated above, in the exemplary embodiment, the first threshold value is a geographical distance of 50 miles, however, in other embodiments, the first threshold value can be any another geographical distance chosen by the user or administer of server 110. In another embodiment, traveler identification program 112 determines if the average geographical distance of each set surpasses the second threshold value. As stated above, the second threshold value is a geographical distance of 20 miles, however, in other embodiments; the second threshold value can be any other geographical distance chosen by the user or administrator of server 110.

Traveler identification program 112 then determines if the percentage of sets where the maximum geographical distance surpasses the first threshold value, surpasses a third threshold value (decision 308). In the exemplary embodiment, the third threshold value is 75%. Therefore, in the exemplary embodiment, traveler identification program 112 determines the number of sets where the maximum geographical distance surpasses the first threshold value. Traveler identification program 112 then determines the percentage of sets where the maximum geographical distance surpasses the first threshold value by dividing the number of sets where the maximum geographical distance surpasses the first threshold value by the total number of sets in the first plurality of sets. If the percentage of sets where the maximum geographical distance surpasses the first threshold value, surpasses the third threshold value (decision 308, “YES” branch), traveler identification program 112 classifies the first user as a “frequent traveler” (step 312). If the percentage of sets where the maximum geographical distance surpasses the first threshold value, does not surpass the third threshold value (decision 308, “NO” branch), traveler identification program 112 classifies the first user as “not a frequent traveler” (310).

In another embodiment, traveler identification program 112 determines if the percentage of sets where the average distance surpasses the second threshold value, surpasses the third threshold value. In this embodiment, traveler identification program 112 determines the percentage of sets where the average distance surpasses the second threshold value by dividing the number of sets where the average distance surpasses the second threshold value by the total number of sets in the first plurality of sets. If the percentage of sets where the average distance surpasses the second threshold value, surpasses the third threshold value, traveler identification program 112 classifies the first user as a “frequent traveler”. If the percentage of sets where the average distance surpasses the second threshold value, does not surpass the third threshold value, traveler identification program 112 classifies the first user as “not a frequent traveler”.

FIGS. 4 and 5 is a flowchart illustrating the operations of the traveler identification program 112 in building traveling user model 114, using traveling user model 114 to classify a second social media user as a traveler and determining if a second social media user classified as a traveler is a frequent traveler, in accordance with an exemplary embodiment of the invention. In the exemplary embodiment, traveler identification program 112 extracts features from social media messages of social media users who have been classified as “travelers” (step 402). In other embodiments, traveler identification program 112 extracts features from social media messages of social media users who have been classified as “travelers” and also from social media users who have been classified as “non-travelers”. In the exemplary embodiment, traveler identification program 112 extracts features such as word-based features, hash-tag based features, and place-name based features. Word-based features are travel-related words such as “airport”, “train”, “bus”, “transit”, “security”, “TSA”, “flight”, or “custom”. Hash-tag based features are travel-related words that follow a hash-tag symbol such as “#air”, “#travel”, “#vacation”, or “#tour”. Place-name based features are city, state or country names/nicknames such as “Hawaii”, “New York City”, “NYC”, “San Francisco”, “San Diego”, or “Long Beach”.

Traveler identification program 112 then builds traveling user model 114 from the extracted features (step 404). In the exemplary embodiment, each type of feature extracted is categorized and given an accompanying weight based on the importance of each type of feature in determining if a social media user is a traveler. For example, in an exemplary embodiment, word-based features are given a weight of 0.25, place-name based features are given a weight of 0.3 and hash-tag based feature are given a weight of 0.2. In other embodiments, traveler identification program 112 builds a “non-traveler” model from the features extracted from social media messages of “non-travelers”. In the exemplary embodiment, an occurrence factor for a feature category, the calculation which is explained in detail below, is multiplied by the weight of the feature category resulting in a matching value for the feature category.

Traveler identification program 112 then collects a second plurality of social media messages authored by a second social media user from social media site 142 via network 130 (step 406). In the exemplary embodiment, the social media messages of the second plurality of social media messages are not geo-tagged.

Traveler identification program 112 then compares the content of the second plurality of social media messages to the content of traveling user model 114 to determine an overall matching value (step 408). In the exemplary embodiment, for the word-based, hash-tag based and place-name based feature categories, traveler identification program 112 examines the content of the second plurality of social media messages to identify the tokens, i.e., the words and word combinations/phrases, present in the second plurality of social media messages. Once the tokens have been identified, the tokens are compared to a corresponding feature category to determine how many tokens match the content of the feature category. Tokens that are nouns and non-stop words are compared to the content of word-based feature category of traveling user model 114, with adjectives, adverbs, conjunctions, pronouns, prepositions and the like, not being utilized because they are often generic and may not discriminate among locations. For example, traveler identification program 112 uses word or character recognition software to determine how many word-based tokens contained in the second plurality of social media messages match the content contained in the word-based feature category of traveling user model 114. Tokens that start with the # symbol (or any other symbol of interest) are compared to the content of the hash-tag based feature category of traveling user model 114. Tokens that are city, state or country names are compared to the content of the place-name based feature category of traveling user model 114. Traveler identification program 112 then calculates an occurrence factor for each of the three categories by dividing the number of matching tokens by the total number of tokens contained in the second plurality of social media messages. Traveler identification program 112 then multiplies the occurrence factor of each feature category by the corresponding weight value for the feature category to determine a matching value for each feature category.

In the exemplary embodiment, a time-based feature category is also taken into account in the calculation of the overall matching value of the second plurality of social media messages. To calculate the matching value for the time-based feature category, traveler identification program 112 first divides the second plurality of social media messages based on the day and time each social media message was created. For example, if the second plurality of social media messages contains 12 messages, 4 that were created on day 1, 4 that were created on day 2, and 4 that were created on day 3, traveler identification program 112 divides the 12 messages into three groups based on the day they were created and then further divides them based on the time of day they were created. In the exemplary embodiment, there are 6 time slots for each day, each time slot representing a 4 hour period, with the first time slot starting at 12 a.m. and ending at 4 a.m. Therefore, referring back to the example, if of the 4 messages that were created on day 1, the first was created at 12:30 a.m., the second at 6 a.m., the third at 5 p.m., and the fourth at 6 p.m. The first message would be placed into the first time slot of day 1, the second message into the second time slot of day 1, and the third and fourth messages into the fifth time slot of day 1.

In the exemplary embodiment, traveler identification program 112 then compares the social media messages of each respective time slot with the social media messages created in the same time slot but on different days, in order to determine a standard deviation. For example, traveler identification program 112 compares the social media messages created in time slot 1 on day 1 to the social media messages created in time slot 1 on day 2, day 3 and day 4. Traveler identification program 112 then compares the social media messages created in time slot 1 on day 2 to the social media messages created in time slot 1 on day 3 and day 4. Traveler identification program 112 then compares the social media messages created in time slot 1 on day 3 to the social media messages created in time slot 1 on day 4. The same process is repeated for each respective time slot. For each respective time slot comparison, the social media messages are compared chronologically on a 1 to 1 level. For example, the first social media message in time slot 1 on day 1 is compared to the first social media message in time slot 1 on day 2. The second social media message in time slot 1 on day 1 is then compared to the second social media message in time slot 1 on day 2. If there is only one social media message in time slot 1 on day 1 and there are two social media messages in time slot 1 on day 2, the two social media messages in time slot 1 on day 2 are averaged together and the average value is compared to the social media message in time slot on day 1. Traveler identification program 112 determines a standard deviation for each pair of social media messages being compared. Traveler identification program 112 then averages the standard deviation values computed for each respective time slot to determine an average standard deviation value for each respective time slot.

Traveler identification program 112 then multiplies the average standard deviation value for each respective time slot by the corresponding weight value associated with each respective time slot resulting in the matching value for each respective time slot. The weight value accounts for the fact that during certain times of the day, such as between 4 p.m. and 8 p.m., notable variations in social media message creation time are less likely, since the average user typically has a social media block built into their routine, whereas, for the time slot of 12 a.m. to 4 a.m., notable variations in social media message creation time are more likely. In the exemplary embodiment, the weight values for each respective time slot are: 0.03 for the 12 a.m. to 4 a.m. time slot, 0.03 for the 4 a.m. to 8 a.m. time slot, 0.04 for the 8 a.m. to 12 p.m. time slot, 0.05 for the 12 p.m. to 4 p.m. time slot, 0.06 for the 4 p.m. to the 8 p.m. time slot, and 0.05 for the 8 p.m. to 12 a.m. time slot. Traveler identification program 112 then adds the matching values for each time slot together to determine the matching value for the time-based feature category.

Traveler identification program 112 then adds the matching values of each feature category together to determine an overall matching value for the second plurality of social media messages.

Traveler identification program 112 then determines if the overall matching value for the second plurality of social media messages surpasses a fourth threshold value (decision 410). In the exemplary embodiment, the fourth threshold value is 0.25. If the overall matching value for the second plurality of social media messages surpasses the fourth threshold value (decision 410, “YES” branch), traveler identification program 112 classifies the second social media user as a “traveler” (step 414). If the overall matching for the second plurality of social media messages does not surpass the fourth threshold value (decision 412, “NO” branch), traveler identification program 112 classifies the second social media user as a “non-traveler” (step 412).

In other embodiments, traveler identification program 112 also compares the content of the second plurality of social media messages to the content of the “non-traveler” model to determine an overall matching value. Traveler identification program 112 then compares the overall matching value of the second plurality of social media messages and traveling user model 114 to the overall matching value of the second plurality of social media messages and the “non-traveler” model. If the overall matching value of the second plurality of social media messages and traveling user model 114 is greater than the overall matching value of the second plurality of social media messages and the “non-traveler” model, traveler identification program 112 classifies the second social media user as a “traveler”. If the overall matching value of the second plurality of social media messages and the “non-traveler” model is greater than the overall matching value of the second plurality of social media messages and traveling user model 114, traveler identification program 112 classifies the second social media user as a “non-traveler”.

If the second social media user is classified as a “traveler” (step 414), traveler identification program 112 divides the second plurality of social media messages into a second plurality of sets, each set containing at least two social media messages (step 502). Traveler identification program 112 then determines an overall matching value for each set of the second plurality of sets (step 504). In the exemplary embodiment, the overall matching value of each set of the second plurality of sets is determined in a similar fashion as described in step 408.

Traveler identification program 112 then determines if the overall matching value of each set of the second plurality of sets surpasses the fourth threshold value (step 506).

Traveler identification program 112 then determines if the percentage of sets where the overall matching value of each set surpasses the fourth threshold value, surpasses a fifth threshold value (decision 508). In the exemplary embodiment, the fifth threshold value is 50%. If the percentage of sets where the overall matching value of the set surpasses the fourth threshold value, surpasses a fifth threshold value (decision 508, “YES” branch), traveler identification program 112 classifies the second social media user as a “frequent traveler” (step 512). If the percentage of sets where the overall matching value of the set surpasses the fourth threshold value, does not surpass a fifth threshold value (decision 508, “NO” branch), traveler identification program 112 classifies the second social media user as “not a frequent traveler” (step 510).

If the second social media user is classified as a “traveler” or a “frequent traveler”, traveler identification program 112 can determine the locations where the second social media user has traveled “from/to” by first dividing the second plurality of social media messages into a third plurality of sets, where each set contains at least two social media messages (step 602). The third plurality of sets can be the same or different from the second plurality of sets.

Traveler identification program 112 then determines the “from/to” location of a set of the third plurality of sets by using a content-based location detection algorithm. In the exemplary embodiment, traveler identification program 112 performs the content-based location detection algorithm by first building trained statistical model 116 via a training dataset. In the exemplary embodiment, trained statistical model 116 contains three statistical classifiers: a word-based classifier, a hash-tag based classifier, and a place-name based classifier. In other embodiments, trained statistical model 116 can also include a heuristic classifier and a behavior based classifier. The training dataset is a group of social media messages, with each social media message containing a location associated with the user who generated the social media message. During the training process, traveler identification program 112 inputs the features of each social media message of the training dataset into the appropriate classifier. For example, for the social media message: “Going to the Big Apple #citythatneversleeps”, traveler identification program 112 inputs the phrase “Big Apple”, into the word-based classifier and the phrase “citythatneversleeps” into the hash-tag based classifier. In the exemplary embodiment, word-based features input from the training dataset into the word-based classifier are not limited to travel-related words. The location of each social media message of the training dataset is also input into the appropriate classifier. Statistical machine learning processes are then performed for each classifier based on these inputs. As a result of this training process, trained statistical model 116 is generated for use during the location classification process.

In the exemplary embodiment, once trained statistical model 116 is generated, traveler identification program 112 identifies the tokens contained within each set of the third plurality of sets. Traveler identification program 112 then passes each of the tokens through the corresponding statistical classifier of trained statistical model 116. For example, traveler identification program 112 passes words/phrases that follow a hash-tag through the hash-tag based classifier. Each statistical classifier then outputs a location classification comprising the location with the highest probability of being the location of the user. For example, the word-based classifier outputs a location based on word features extracted from the social media messages. The hash-tag based classifier outputs a location based on the hash-tag features extracted from the social media messages. The place-name classifier outputs a location based on place names features extracted from the social media messages. Each location output by the classifiers has a corresponding weight. If any of the locations are the same, the weights are combined. The location with the highest weight is output as the location of the social media user.

Traveler identification program 112 then determines an overall matching value for each set of the third plurality of sets (step 606). The overall matching value is determined in a similar fashion as described in step 408, except the determination is made for each respective set of social media messages, rather than for the entirety of the second plurality of social media messages.

Traveler identification program 112 then determines if the overall matching value of each set of the third plurality of sets surpasses the fourth threshold value (decision 608). If the overall matching value for each set of the third plurality of sets surpasses the fourth threshold value (decision 608, “YES” branch), traveler identification program 112 moves onto decision 702. If the overall matching value of each set of the third plurality of sets does not surpass the fourth threshold value (decision 608, “NO” branch), traveler identification program 112 sets aside each set of the third plurality of sets that does not surpass the fourth threshold value (step 610). Traveler identification program 112 then determines if all sets of the third plurality of sets have been set aside (decision 612). If traveler identification program 112 determines that all sets have been set aside (decision 612, “YES” branch), then all “from/to” locations for the second plurality of social media messages, capable of being determined by traveler identification program 112, have been determined.

If traveler identification program 112 determines that all sets have not been set aside (decision 612, “NO” branch), traveler identification program 112 determines if the “from” location of a set is the same as the “to” location of the same set, for at least one set of the third plurality of sets or if either the “from” or “to” location of at least one set of the third plurality of sets is unable to be determined (decision 702). If all “from/to” location pairs of each set of the third plurality of sets are different and if all “from” and “to” locations in each set of the third plurality of sets are able to be determined (decision 702, “NO” branch), traveler identification program 112 divides each set of the third plurality of sets, into a multiple of sets (step 704). For example, if the third plurality of sets contains three sets and each set has a determined “from” and “to” location and the determined “from” and “to” location of each set is different, traveler identification program 112 divides each of the three sets into a multiple of sets. In the exemplary embodiment, each of the three sets is divided in two resulting in six sets, however, in other embodiments; the sets can be divided into an even greater number of sets. Traveler identification program 112 then returns back to step 604 and determines the “from” and “to” locations for each of the sets of the third plurality of sets, that have not been set aside, by using the content-based location detection algorithm discussed above (step 604).

If the “from” and “to” location of a set are the same, for at least one set of the third plurality of sets, or if either the “from” or “to” location of at least one set of the third plurality of sets is unable to be determined (decision 702, “YES” branch), traveler identification program 112 sets aside each set of the third plurality of sets where the “from” location of the set is the same as the “to” location of the same set or where the “from” or “to” location is unable to be determined (step 706). For example, if the third plurality of sets contains three sets and traveler identification program 112 determines that the first set has the same “from” and “to” location, the second set has a different “from” and “to” location, and the third set has an undeterminable “from” location, traveler identification program 112 will set the first and third set aside.

Traveler identification program 112 then determines if all the sets of the third plurality of sets have been set aside (decision 708). If traveler identification program 112 determines that all the sets of the third plurality of sets have been set aside (decision 708, “YES” branch), then all “from/to” locations for the second plurality of social media messages, capable of being determined by traveler identification program 112, have been determined. If traveler identification program 112 determines that all the sets of the third plurality of sets have not been set aside (decision 708, “NO” branch), traveler identification program 112 divides each set of the third plurality of sets, which have not been set aside, into a multiple of sets (step 704). Traveler identification program 112 then returns back to step 604 and determines the “from” and “to” locations for each of the sets of the third plurality of sets, which have not been set aside, by using the location detection algorithm discussed above (step 604).

The foregoing description of various embodiments of the present invention has been presented for purposes of illustration and description. It is not intended to be exhaustive nor to limit the invention to the precise form disclosed. Many modifications and variations are possible. Such modifications and variations that may be apparent to a person skilled in the art of the invention are intended to be included within the scope of the invention as defined by the accompanying claims.

FIG. 8 depicts a block diagram of components of server 110, computing device 120 and social media server 140 in accordance with an illustrative embodiment of the present invention. It should be appreciated that FIG. 8 provides only an illustration of one implementation and does not imply any limitations with regard to the environments in which different embodiments may be implemented. Many modifications to the depicted environment may be made.

Server 110, computing device 120 and social media server 140 include communications fabric 802, which provides communications between computer processor(s) 804, memory 806, persistent storage 808, communications unit 812, and input/output (I/O) interface(s) 814. Communications fabric 802 can be implemented with any architecture designed for passing data and/or control information between processors (such as microprocessors, communications and network processors, etc.), system memory, peripheral devices, and any other hardware components within a system. For example, communications fabric 802 can be implemented with one or more buses.

Memory 806 and persistent storage 808 are computer-readable storage media. In this embodiment, memory 806 includes random access memory (RAM) 816 and cache memory 818. In general, memory 806 can include any suitable volatile or non-volatile computer-readable storage media.

The programs traveler identification program 112, traveling user model 112 and trained statistical model 116 in server 110; programs social media application 122 and user interface 124 in computing device 120; and programs social media site 142 in social media server 140 are stored in persistent storage 808 for execution by one or more of the respective computer processors 804 via one or more memories of memory 806. In this embodiment, persistent storage 808 includes a magnetic hard disk drive. Alternatively, or in addition to a magnetic hard disk drive, persistent storage 808 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 808 may also be removable. For example, a removable hard drive may be used for persistent storage 808. Other examples include optical and magnetic disks, thumb drives, and smart cards that are inserted into a drive for transfer onto another computer-readable storage medium that is also part of persistent storage 808.

Communications unit 812, in these examples, provides for communications with other data processing systems or devices. In these examples, communications unit 812 includes one or more network interface cards. Communications unit 812 may provide communications through the use of either or both physical and wireless communications links. The programs traveler identification program 112, traveling user model 114 and trained statistical model 116 in server 110; programs social media application 122 and user interface 124 in computing device 120; and programs social media site 142 in social media server 140 may be downloaded to persistent storage 808 through communications unit 812.

I/O interface(s) 814 allows for input and output of data with other devices that may be connected to server 110, computing device 120 and social media server 140. For example, I/O interface 814 may provide a connection to external devices 820 such as a keyboard, keypad, a touch screen, and/or some other suitable input device. External devices 820 can also include portable computer-readable storage media such as, for example, thumb drives, portable optical or magnetic disks, and memory cards. Software and data used to practice embodiments of the present invention, e.g., programs traveler identification program 112, traveling user model 114 and trained statistical model 116 in server 110; programs social media application 122 and user interface 124 in computing device 120; and programs social media site 142 in social media server 140, can be stored on such portable computer-readable storage media and can be loaded onto persistent storage 808 via I/O interface(s) 814. I/O interface(s) 814 can also connect to a display 822.

Display 822 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for determining that a social media user is a traveler, comprising:
collecting a first plurality of social media messages, wherein each of the first plurality of social media messages contains a respective location of a first social media user;
determining a first plurality of geographical distances between the respective locations contained in the first plurality of social media messages;
determining a maximum geographical distance or an average geographical distance from the first plurality of geographical distances;
determining that the maximum geographical distance surpasses a first threshold value or the average geographical distance surpasses a second threshold value; and
classifying the first social media user as a traveler.

2. The method of claim 1, further comprising:
dividing the first plurality of social media messages into a first plurality of sets;
determining a second plurality of geographical distances between the respective locations contained in the social media messages of each set of the first plurality of sets; and
determining that the first social media user is a frequent traveler based on the second plurality of geographical distances.

3. The method of claim 2, wherein determining that the first social media user is a frequent traveler based on the second plurality of geographical distances comprises:
determining a maximum geographical distance for each set from the second plurality of geographical distances;
determining that the number of sets of the first plurality of sets, where the maximum geographical distance surpasses the first threshold value, surpasses a third threshold value; and
classifying the first social media user as a frequent traveler.

4. The method of claim 2, wherein determining that the first social media user is a frequent traveler based on the second plurality of geographical distances comprises:
determining an average geographical distance for each set from the second plurality of geographical distances;
determining that the number of sets of the first plurality of sets, where the average geographical distance surpasses the second threshold value, surpasses a third threshold value; and
classifying the first social media user as a frequent traveler.

5. The method of claim 1, further comprising:
extracting content from the first plurality of social media messages; and
creating a traveler model from the extracted content.

6. The method of claim 5, further comprising:
collecting a second plurality of social media messages, wherein the second plurality of social media messages are authored by a second social media user;
determining that an amount of content contained in the second plurality of social media messages that matches the content contained in the traveler model surpasses a fourth threshold value; and
classifying the second social media user as a traveler.

7. The method of claim 6, further comprising:
dividing the second plurality of social media messages into a second plurality of sets;
determining that the number of sets of the second plurality of sets, where the amount of content contained in the social media messages of the set that matches the content contained in the traveler model surpasses the fourth threshold value, surpasses a fifth threshold value; and
classifying the second social media user as a frequent traveler.

8. The method of claim 6, further comprising:
dividing the second plurality of social media messages into a third plurality of sets, wherein each set of the third plurality of sets has a first message and a second message;
determining that a first set of the third plurality of sets contains enough content that matches the content contained in the traveler model to surpass the fourth threshold value;
analyzing the first message of the first set to determine a first location of the second social media user;
analyzing the second message of the first set to determine a second location of the second social media user;
determining that the first location is different from the second location; and
dividing the first set into a fourth plurality of sets.

9. A computer program product for determining that a social media user is a traveler, the computer program product comprising:
one or more computer-readable storage mediums having program instructions embodied therewith, the program instructions executable by a computer to:
collect a first plurality of social media messages, wherein each of the first plurality of social media messages contains a respective location of a first social media user;
determine a first plurality of geographical distances between the respective locations contained in the first plurality of social media messages;
determine a maximum geographical distance or an average geographical distance from the first plurality of geographical distances;
determine that the maximum geographical distance surpasses a first threshold value or the average geographical distance surpasses a second threshold value; and
classify the first social media user as a traveler.

10. The computer program product of claim 9, further comprising program instructions to:
divide the first plurality of social media messages into a first plurality of sets;
determine a second plurality of geographical distances between the respective locations contained in the social media messages of each set of the first plurality of sets; and
determine that the first social media user is a frequent traveler based on the second plurality of geographical distances.

11. The computer program product of claim 10, wherein the program instructions to determine that the first social media user is a frequent traveler based on the second plurality of geographical distances comprises program instructions to:
determine a maximum geographical distance for each set from the second plurality of geographical distances;
determine that the number of sets of the first plurality of sets, where the maximum geographical distance surpasses the first threshold value, surpasses a third threshold value; and
classify the first social media user as a frequent traveler.

12. The computer program product of claim 10, wherein the program instructions to determine that the first social media user is a frequent traveler based on the second plurality of geographical distances comprises program instructions to:
determine an average geographical distance for each set from the second plurality of geographical distances;
determine that the number of sets of the first plurality of sets, where the average geographical distance surpasses the second threshold value, surpasses a third threshold value; and
classify the first social media user as a frequent traveler.

13. The computer program product of claim 9, further comprising program instructions to:
extract content from the first plurality of social media messages; and
create a traveler model from the extracted content.

14. The computer program product of claim 13, further comprising program instructions to:
collect collecting a second plurality of social media messages, wherein the second plurality of social media messages are authored by a second social media user;
determine that an amount of content contained in the second plurality of social media messages that matches the content contained in the traveler model surpasses a fourth threshold value; and
classify the second social media user as a traveler.

15. The computer program product of claim 14, further comprising program instructions to:
divide the second plurality of social media messages into a second plurality of sets;
determine that the number of sets of the second plurality of sets, where the amount of content contained in the social media messages of the set that matches the content contained in the traveler model surpasses the fourth threshold value, surpasses a fifth threshold value; and
classify the second social media user as a frequent traveler.

16. The computer program product of claim 14, further comprising program instructions to:
divide the second plurality of social media messages into a third plurality of sets, wherein each set of the third plurality of sets has a first message and a second message;
determine that a first set of the third plurality of sets contains enough content that matches the content contained in the traveler model to surpass the fourth threshold value;
analyze the first message of the first set to determine a first location of the second social media user;
analyze the second message of the first set to determine a second location of the second social media user;
determine that the first location is different from the second location; and
divide the first set into a fourth plurality of sets.

17. A method for determining that a social media user is a traveler, comprising:
collecting a first plurality of social media messages, wherein each of the first plurality of social media messages either contains a respective location of a first social media user or no respective location of the first social media user;
if a percentage of said messages of the first plurality of social media messages that contain a location surpasses a first threshold value: (i) determining a first plurality of geographical distances between the respective locations contained in the first plurality of social media messages; (ii) determining a maximum geographical distance or an average geographical distance from the first plurality of geographical distances; (iii) determining that the maximum geographical distance surpasses a second threshold value or the average geographical distance surpasses a third threshold value; and (iv) classifying the first social media user as a traveler; and
if a percentage of said messages of the first plurality of social media messages that contain a location does not surpass a first threshold value: (i) extracting content from the first plurality of social media messages; (ii) determining that an amount of extracted content from the first plurality of social media messages that matches the content contained in a traveler model surpasses a fourth threshold value; and (iii) classifying the first social media user as a traveler.

18. The method of claim 17, wherein if a percentage of said messages of the first plurality of social media messages that contain a location surpasses a first threshold value, further comprising: (i) dividing the first plurality of social media messages into a first plurality of sets; (ii) determining a second plurality of geographical distances between the respective locations contained in the social media messages of each set of the first plurality of sets; (iii) determining a maximum geographical distance or an average geographical distance for each set from the second plurality of geographical distances; (iv) determining the number of sets of the first plurality of sets, where the maximum geographical distance surpasses the second threshold value or the average geographical distance surpasses the third threshold value, surpasses a fifth threshold value; and (v) classifying the first social media user as a frequent traveler.

19. The method of claim 17, wherein if a percentage of said messages of the first plurality of social media messages that contain a location does not surpass the first threshold value, further comprising: (i) dividing the first plurality of social media messages into a first plurality of sets; (ii) determining that the number of sets of the first plurality of sets, where the amount of content contained in the social media messages of the set that matches the content contained in the traveler model surpasses the fourth threshold value, surpasses a fifth threshold value; and (iii) classifying the first social media user as a frequent traveler.

20. The method of claim 17, wherein said traveler model is created by extracting features from social media messages of social media users who have been classified as travelers.
